(19) United States
(12) Patent Application Publication
(10) Pub. No.: US 2015/0161752 A1
(43) Pub. Date: Jun. 11, 2015

(54) INTELLIGENT QUEUING FOR USER SELECTION IN PROVIDING ON-DEMAND SERVICES

(71) Applicant: Uber Technologies Inc., San Francisco, CA (US)

(72) Inventors: Amos Barreto, San Francisco, CA (US); Laszlo Korsos, San Francisco, CA (US)

(21) Appl. No.: 14/566,229

(22) Filed: Dec. 10, 2014

Related U.S. Application Data
(60) Provisional application No. 61/914,885, filed on Dec. 11, 2013.

(51) Int. Cl. G06Q 50/30; G06Q 10/06

(52) U.S. Cl. CPC G06Q 50/30; G06Q 10/063114; G06Q 10/06316

(57) ABSTRACT

A system and method for arranging an on-demand service is described. A computing device can maintain a queue that includes a plurality of user identifiers corresponding to a plurality of users. Each user identifier is added to the queue in response to receiving a request for service from a corresponding user. The computing device receives information from a device of a service provider that the service provider is available to provide service to users. In response to receiving the information, the computing device selects a user identifier from the queue to assign a corresponding user to the service provider based, at least in part, on specified on-demand service locations corresponding to the plurality of user identifiers and a current location of the service provider.

### RELATED APPLICATION

This application is a non-provisional filing that claims the benefit of U.S. Provisional Patent Application No. 61/914,885, filed Dec. 11, 2013, titled INTELLIGENT QUEUING FOR USER SELECTION IN PROVIDING ON-DEMAND SERVICES; the aforementioned application being incorporated by reference in its entirety.

### BACKGROUND

On-demand service arrangement systems exist that arrange for transport services to be provided for a user by a driver of a vehicle. For example, in many cases, a user that requests a transport service may be provided the first available driver or the closest driver to the user's requested pickup location.

### BRIEF DESCRIPTION OF THE DRAWINGS

FIG. 1 illustrates an example system to arrange an on-demand service using one or more queues.

FIGS. 2A and 2B illustrate example methods for arranging an on-demand service for a user using one or more queues.

FIG. 3 illustrates an example of a queue maintained by an on-demand service system.

FIG. 4 is a block diagram that illustrates a computer system upon which examples described herein may be implemented.

FIG. 5 is a block diagram that illustrates a mobile computing device upon which examples described herein may be implemented.

### DETAILED DESCRIPTION

Examples described herein provide for an intelligent dispatch system that arranges an on-demand service to be provided for a requesting user by a service provider. According to some examples, during times of high utilization of service providers in a given region, such as when the number of available service providers are low and/or the number of requesting users are high in the given region (e.g., as a result of many service providers already providing service to users), the dispatch system can maintain one or more queues for a plurality of users that have made requests for the on-demand service. When a service provider becomes available, the dispatch system can select a user from the queue(s) and assign that user to the service provider. The dispatch system can select a particular user from the queue(s) based on the location information pertinent to the user and location information of the service provider.

For example, the dispatch system maintains one or more queues, e.g., in a database stored in a memory resource, that includes a plurality of user identifiers corresponding to a plurality of users. The one or more queues can be updated in real-time (e.g., updated dynamically) by the dispatch system. For example, the dispatch system can add (or store) a user identifier to the queue in response receiving a request for transport from the corresponding user or can remove (or delete) a user identifier from the queue after an expiration of a duration of time (e.g., two minutes). In one example, for a given geographic area or region, during times of high utilization, a plurality of users may individually request a transport service within a short period of time of each other, and no drivers (e.g., service providers) may be available to provide the transport service within the given geographic region. In such conditions, the dispatch system may place the user identifiers for those users in a respective user queue and continue to determine whether a transport service can be arranged for any of those users for a duration of time as opposed simply transmitting an error message (e.g., “Sorry, no driver available” message) to the requesting users' devices.

When a driver in the given geographic region becomes available, the dispatch system can receive information, from the driver's device, indicating that the driver is available to provide transport to users (e.g., is on-duty and capable of providing transport) as well as the current location of the driver. For example, the driver can operate a service application running on his or her mobile computing device to update his or her status from being unavailable to available. The information about the driver's availability can be provided to the dispatch system over one or more networks. In response to receiving the information indicating that the driver is available, the dispatch system can select a user identifier from the queue to assign the corresponding user to the driver based on the pickup locations of the user identifiers in the queue and the current location of the driver.

According to an example, the dispatch system can also maintain the plurality of user identifiers in the one or more queues based on a timestamp in which the dispatch system received the transport request from a respective user (or a timestamp in which the respective user made the transport request). In this manner, the user identifiers can be placed in an order or grouped in a respective queue so that the dispatch system can select a user identifier from a first set of identifiers having an older timestamp as compared to a second set of identifiers having a newer timestamp.

In some examples, when the dispatch system receives information indicating that a driver is available in a given region, the dispatch system can determine the estimated travel time from the driver's current location to the individual pickup locations of one or more user identifiers in the queue corresponding to the given region. For example, the dispatch system can determine the estimated travel time from the driver's current location (e.g., the current location at the time the driver device transmitted information indicating that the driver was available) to the respective pickup location for each user in the first set of identifiers in the queue (e.g., five user identifiers) and select a user having a pickup location corresponding to the shortest estimated travel time for the driver. In another example, the dispatch system can determine the total distance to be traveled by the driver to the respective pickup location for each user in the first set of identifiers in the queue and select a user having a pickup location corresponding to the shortest total distance to be traveled by the driver. By selecting from the queue or from a set of identifiers in the queue (e.g., from those identifiers having the oldest time stamps or time stamps exceeding a predefined duration from the current time), the dispatch system can select a user that has been waiting a longer period of time than another set of users, while continuing to optimize for the selection of a user for the available driver.

As used herein, a client device, a driver device, and/or a computing device refer to devices corresponding to desktop computers, cellular devices or smartphones, personal digital assistants (PDAs), laptop computers, tablet devices, television (IP Television), etc., that can provide network connectivity and processing resources for communicating with the system over a network. A driver device can also correspond to an in-vehicle computing device of a transit object, or custom hardware, etc. The client device and/or the driver device can also each operate a designated service application configured to communicate with the intelligent dispatch system (e.g., a client service application and a driver service application, respectively).

Still further, while some examples described herein relate to transport services, the system can enable other on-demand location-based services (for example, a food truck service, a delivery service, an entertainment service) to be arranged between individuals and service providers. For example, a user can request an on-demand service, such as a delivery service (e.g., food delivery, messenger service, food truck service, or product shipping) or an entertainment service (e.g., mariachi band, string quartet) using the intelligent dispatch system, and the system can select a service provider, such as a driver, food provider, band, etc., to provide the on-demand service for the user.

As used herein, a queue refers to a data structure which can be stored in a medium such as a cache or other memory resource. In the context of examples provided, the queue is an aggregation of data items, each of which are based on or otherwise correspond to a transport request. A selection process can be associated by default with the queue in order to pair the transport requests of the queue with drivers, vehicles or other resources which can provided the transport requested. The implementation of the selection process can rely on use of characteristics associated with individual data entries of the queue, including position information (e.g., pickup location) provided with the corresponding transport requests. As such, the manner in which transport requests are resolved and eliminated from the queue may not reflect any natural sequence, but rather are derived from intelligent and programmatic determinations which are based at least partially on, for example, position information provided with the corresponding transport requests. In some examples, the queue can be characterized by a duration which corresponds to the age or length of time any one entry can reside as part of the queue, without (i) the entry being removed from the queue, or (ii) the entry being designated for special handling outside of the default queue selection process.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. Examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

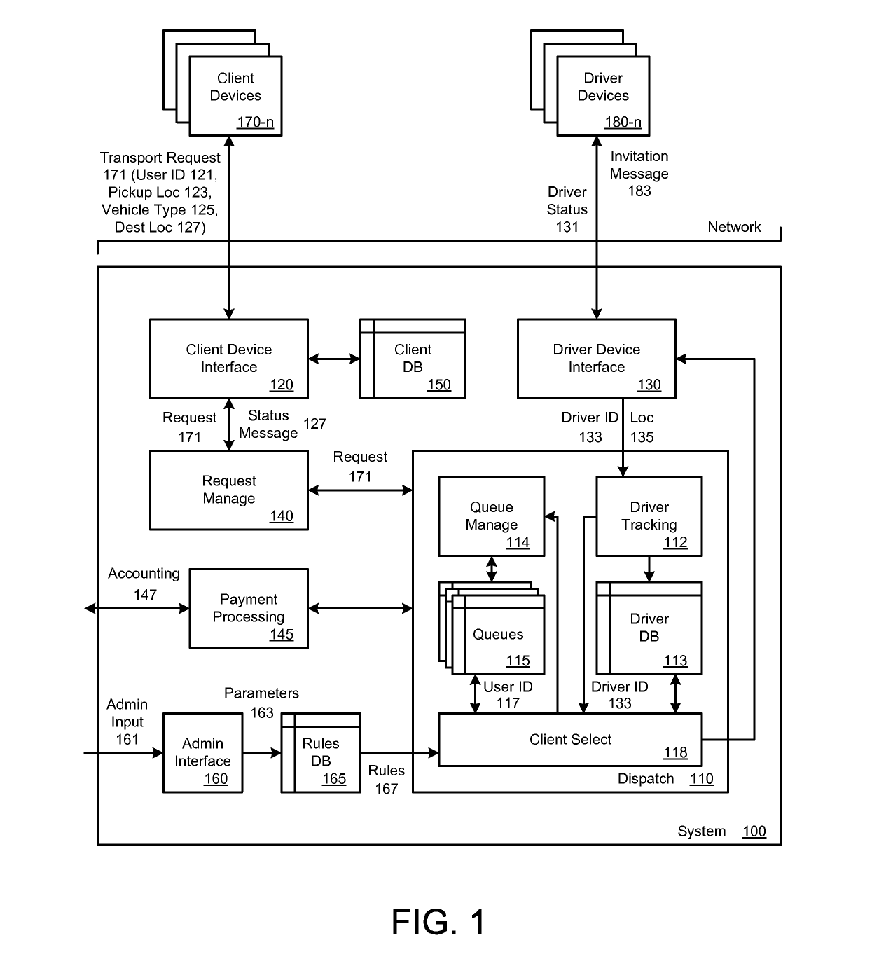

FIG. 1 illustrates an example dispatch system to arrange an on-demand service to be provided for a user, according to an example. In some examples described herein, during times of high utilization of service providers in a given region, the system can maintain a queue for a plurality of users using the respective users' identifiers or user names. Users that are in the queue may have made a request for an on-demand service, but have not yet been assigned a service provider. When the system receives information from a service provider indicating that the service provider has become available for providing service in the given region, the system can intelligently select a first user from the queue and assign that first user to that service provider based on the specified location information of the users (e.g., pickup locations) in the queue and the service provider's current location.

According to an example, the system 100 includes a dispatch 110, a client device interface 120, a driver device interface 130, a request manage 140, a payment processing 145, and an administrator interface 160. The system 100 also includes a plurality of databases for storing records and information, including at least a client database 150, a rules database 165, and a driver database 113. A plurality of client devices 170 and a plurality of driver devices 180 can communicate with the system 100 over one or more networks using, for example, respective designated service applications (e.g., configured to communicate with the system 100). The components of the system 100 can combine to arrange a transport service for a user by selecting the user from a queue when a driver becomes available. Logic can be implemented with various applications (e.g., software) and/or with hardware of a computer system that implements the system 100.

Depending on implementation, one or more components of the system 100 can be implemented on network side resources, such as on one or more servers. The system 100 can also be implemented through other computer systems in alternative architectures (e.g., peer-to-peer networks, etc.). As an addition or an alternative, some or all of the components of the system 100 can be implemented on client devices, such as through applications that operate on the client devices 170 and/or the driver devices 180. For example, a client application, such as a designated service application, can execute to perform one or more of the processes described by the various components of the system 100. The system 100 can communicate over one or more networks, via a network interface (e.g., wirelessly or using a wireline), to communicate with the one or more client devices 170 and the one or more driver devices 180.

The system 100 can communicate, over one or more networks, with client devices 170 and driver devices 180 using the client device interface 120 and the device interface 130, respectively. The device interfaces 120, 130 can each manage communications between the system 100 and the respective computing devices 170, 180. In some examples described herein, the client devices 170 and the driver devices 180 can individually operate a service application that can interface with the device interfaces 120, 130, respectively, to communicate with the system 100. According to some examples, the applications can include or use an application programming interface (API), such as an externally facing API, to communicate data with the device interfaces 120, 130. The externally facing API can provide access to the system 100 via secure access channels over the network through any number of methods, such as web-based forms, programmatic access via restful APIs, Simple Object Access Protocol (SOAP), remote procedure call (RPC), scripting access, etc.

According to examples described herein, a user of a client device 170 can operate the service application on her client device 170 to make a transport request 171 for a transport service. The transport request 171 can be automatically generated in response to the user providing user input to place an order for the transport service (e.g., in response to a selection of a feature on a user interface of the application). In one example, the transport request 171 can include a user identifier (ID) 121, a pickup location 123, a vehicle type 125, and/or a destination location 127. Depending on implementation, in some cases, the user may not be required to provide a destination location 127 when making the transport request 171. The service application can automatically determine the current location of the client device 170 as the pickup location 123 (e.g., as a default setting) or can identify a location specified by the user via a user input as the pickup location 123. For example, the user can input an address, street intersection, or name of a place (e.g., store, restaurant, building, park, a place of interest, etc.), or move a selectable feature that is displayed on a map to indicate the pickup location 123.

The system 100 can receive the transport request 171 over one or more networks (e.g., over a cellular network) via the client device interface 120. In one example, the request manage 140 can process the transport request 171 by updating and storing information about the transport request 171 in the client database 150 for the requesting user (e.g., using the respective user ID 121). The request manage 140 can manage the transaction for a requesting user by, for example, (i) communicating with the dispatch 110 to determine the status of drivers, (ii) providing communications to the client device 170 regarding the status of the requested transport service, (iii) providing information when the transport service has been completed and/or (iv) maintaining and updating client information for the user in the client database 150.

Typically, when a user makes a transport request 171, the dispatch 110 can select a driver from a pool of available drivers for the user (e.g., normal transport arrangement mode). For example, within a given geographic region in which the user requested pickup (e.g., within a metropolitan area, or within the city limits or neighborhood of a particular city), a plurality of drivers may be on-duty and available for providing transport. The dispatch 110 can maintain a driver database 113, which is periodically updated with real-time or close to real-time driver information (e.g., driver status and driver current location) by communicating with the driver devices 180. The dispatch 110 can select a driver and send an invitation message to the driver device 180 asking the driver if he or she wants to provide transport for the requesting user. If the driver accepts the invitation, the user can be provided an update regarding the status of the transport request, e.g., that a driver has been selected and is traveling to the user's pickup location.

However, in some cases, such as during times of high utilization, no drivers may be currently available to provide transport at the time the system 100 receives the transport request 171. For example, in a given region, such as in San Francisco, California, there may be an event (such as a concert or sporting event) occurring at a time that causes many users to request transport services with the system 100. In another example, at certain times during the week, such as on a Friday evening, many people within the city may request transport services around the same time (e.g., to meet with friends, to go out to dinner, etc.). A time of high utilization can be a time when one or more users have requested transport service but no drivers are available when the request is received by the system 100 (e.g., no drivers are available that are within a particular or predetermined distance of the one or more users' pickup location). In other examples, a time of high utilization can correspond to a number of drivers in a given region as compared the number of users that have the service applications running on the respective devices in that region (even if no transport request has been made by those users) being less than a predetermined ratio.

Still further, in another example, a time of high utilization may also be a time when the number of drivers, in general, are significantly less than the number of users requesting transport at a given time (e.g., two times less). For example, drivers that are proximate to a user's pickup location or within a predefined geographic region of the user's pickup location may be unavailable because the drivers may be currently providing transport for other users or may be off duty. Based on current conditions (e.g., the number of available drivers in a given region and/or the number of users who have made transport requests), the dispatch 110 can determine which geographic regions, if any, are operating in a time (or duration) of high utilization. In such times of high utilization, the dispatch 110 can use user queues in order to arrange transport services.

According to some examples, the dispatch 110 can include a queue manage 114, a plurality of queue databases (or queues) 115, a driver tracking 112, a driver database 113, and a client select 118. When the dispatch 110 determines that the high utilization condition is present in a given geographic region, the queue manage 114 can receive information to operate the dispatch 110 in a high utilization mode (as opposed to the normal transport arrangement mode during normal conditions). When a client device 170 makes and transmits a transport request 171 to the system 100, the request manage 140 can provide the transport request 171 (or relevant information from the transport request 171, such as the pickup location 123 and the vehicle type 125) to the dispatch 110, such as to the queue manage 114. In the high utilization mode, rather than transmitting an error message or a “no driver available message” to the requesting user because no drivers are available in the given region, the queue manage 114 can place the user ID 121 of the requesting user in a particular queue 115 based on the information from the transport request 171.

For example, the queue manage 114 can maintain a plurality of queues 115 that each corresponds to a different geographic area or region. The geographic areas or regions can correspond to a metropolitan city and/or surrounding area, a city, a town, multiple towns, a portion or neighborhood of a city, a county, a state, a country, etc., and/or be designated by an administrator of the system 100 using a plurality of location data points (e.g., five points of a perimeter identifying a region on a map). With reference to Northern California, for example, the plurality of queues 115 can include a first queue for San Francisco, Calif., a second queue for the peninsula area of Northern California, a third queue for San Jose, Calif., a fourth queue for Marin County, Calif., a fifth queue for Oakland, Calif., a sixth queue for Fremont, Calif., etc. Based on the pickup location 123 provided by the user, the queue manage 114 can include the user ID 121 to an appropriate queue 115.

The plurality of queues 115 can also be maintained based on both the geographic region as well as vehicle types. For example, when a user makes a transport request 171, the user can select a type of vehicle for the transport service (e.g., a black car or sedan, an SUV, a limousine, a hybrid, a cab, any vehicle type, etc.). Information about the selected vehicle type 125 can be provided as part of the transport request 171 and be provided to the queue manage 114. The queue manage 114 can place the user ID 121 to an appropriate queue based on the vehicle types. In one example, each entry in a queue for a particular geographic region can include a user ID, a pickup location, a timestamp, and a vehicle type. As an addition or an alternative, there can be a plurality of queues corresponding to different vehicle types for a particular geographic region. For example, referring to the example of Northern California, the plurality of queues 115 can include a first queue for black sedans in San Francisco, Calif., a second queue for SUVs in San Francisco, Calif., a third queue for any vehicle type in San Francisco, Calif., etc.

Referring back to the queue manage 114, the queue manage 114 can determine which geographic region the requesting user's pickup location 123 is located in and/or the vehicle type 125 requested by the user. Based on this information, the queue manage 114 assigns or places the user ID 121 of the requesting user in a particular queue 115. In addition, the queue manage 114 can track the time in which the transport request 171 was made by the user. As a result, during times of high utilization, for a particular geographic region, a plurality of user IDs can be added to a corresponding queue, with each user ID being ordered as compared to other user IDs by its respective timestamp.

The dispatch 110 can include the driver tracking 112 and the driver database 113. Information about drivers can be stored in the driver database 113. In one example, the driver tracking 112 can receive driver status information 131 from the plurality of driver devices 180 via the driver device interface 130. For example, the driver status information 131 can specify the status of a particular driver, such as whether the driver is active and available, non-active or off-duty, in-use, having vehicle problems, etc. Such status information 131 can be provided by the driver by providing input on a user interface of a service application running on the driver's respective device 180. The driver devices 180 can also provide location information about the driver along with the driver's identifier (ID) 133, such as the current location 135 of the driver (which can be determined by a GPS component of the driver's device 180) or the destination location of the driver. The driver tracking 112 can update the driver database 113 with the driver information in real-time for each respective driver (using the driver IDs 133). In this manner, the dispatch 110 can continually (and/or periodically) monitor the current position and status of drivers that are registered, for example, with the system 100 and have been authorized to provide transport services.

When a driver becomes available, the driver can update his or her status information 131 via his or her driver device 180 indicating that he or she can provide transport to users (e.g., provide input when the driver is on-duty or when the previous transport service that the driver was providing has been completed). The driver tracking 112 can update the driver database 113 for the driver with the driver's status 131 and the driver's current location 135. According to one example, the driver tracking 112 can indicate to the client select 118 that a driver is available and provide the driver ID 133 and/or the driver's current location 135 to the client select 118 (e.g., before or after, or concurrently with updating the driver database 113). As an addition or an alternative, the driver tracking 112 can indicate to the client select 118 that a driver is available and provide the driver ID 133, so that the client select 118 can retrieve the driver's current location 135 and other information for the driver (e.g., vehicle type, ratings information, historical transport service information) from the driver database 113. In another example, the client select 118 can continually or periodically monitor the driver database 113 to detect a change in a status of a driver (from being unavailable or off-duty to being available). By receiving information that a driver is available or detecting that a driver is available, the client select 118 can be triggered, for example, to select a user from the one or more queues 115 based on (i) the driver's vehicle type, (ii) the driver's current location 135, (iii) the selected vehicle types 125 of respective users' IDs in the queue(s) 115, and/or (iv) the pickup locations 123 of respective users' IDs in the queue(s) 115.

According to some examples, the client select 118 can use the driver's current location 135 and the driver's vehicle type to first determine which queue(s) to select a user from. As discussed, the queue manage 114 can manage a plurality of different queues specified by geographic region and/or vehicle type. For example, the driver that indicated that she is available can be located in downtown San Francisco and can be driving an SUV. The client select 118 can determine which geographic region the current location 135 of that driver is located in and can access the appropriate queue of users that have requested transport service at a pickup location within that geographic region, e.g., access a San Francisco queue. In one example, the client select 118 can also access the appropriate queue corresponding to an SUV or “any vehicle” type (which can include SUVs and other vehicles) or identify users from the accessed San Francisco queue of users that requested an SUV or “any vehicle” type. The client select 118 can choose a user from the appropriately identified queue and assign that user to the driver so that the driver is instructed/invited to perform the transport service for that user.

The client select 118 can select a user based on the user information of those users in the identified queue and/or the information about the driver that indicated that he or she is available. In one example, the client select 118 can simply select the user having the oldest timestamp, e.g., the user who made the request before all the other users in that queue. For example, referring back to the previous example, the client select 118 can select from the San Francisco, SUV queue, a user having the oldest timestamp and assign that user to the driver. In other examples, the client select 118 can select a user by performing calculations to determine metrics relating to the user's transport request 171 based on the user's pickup location 123 and information about the drivers retrieved or received from the driver tracking 112 and/or the driver database 113.

For example, the client select 118 can calculate or determine, for each user ID in the identified queue, (i) the distance between the user's pickup location 123 and the current location 135 of the driver (e.g., the current location 135 of the driver device 180), and/or (ii) an estimated travel time for the driver from the current location 135 to the pickup location 123. The client select 118 can select a user based on the distance and/or estimated travel time. Depending on implementation, the distance can correspond to (i) a difference between the two location points (e.g., Cartesian distance difference in a straight line) without taking into consideration an expected or predicted driving route the driver would take to get to the pickup location 123 of a respective user from the current location 135, or (ii) a total distance the driver would take to get to the pickup location 123 of a respective user from the current location 135 based on an expected or predicted route. For example, the client select 118 can (i) determine the distance between the pickup location 123 and the current location 135 of the driver, and select the user having the shortest distance, or (ii) determine the estimated travel time from the current location 135 of the driver location to the pickup location 123, and select the user having the shortest estimated travel time.

The predicted route for determining distance and/or the estimated travel time can be determined by the client select 118 using a variety of information, such as information from other sources (e.g., from other external/remote databases or sources, such as a mapping database, or from other databases of the system 100, not shown in FIG. 1) and information from the driver database 113 about the driver's previously driven routes and/or driving habits (e.g., the driver likes to take a particular street or likes to take freeways instead of local streets when possible). For example, the predicted route and/or the estimated travel time can be determined based on a number of different factors, such as, (i) historical information of the driver with respect to previously routes driven (which can be stored in a driver database 113 and/or a historical database), (ii) current traffic conditions, (iii) the date and/or time of day (e.g., morning, afternoon, late night, rush hour time, etc.), (iv) current weather conditions, (v) mapping information from a map database (e.g., what type of roadways are nearby, tunnels, bridges, one way streets, etc.), and (vi) other information (e.g., street speed limits, train schedules, city event calendars, construction zones, etc.). Such information can be received or retrieved from other sources by the client select 118.

In another example, the client select 118 can determine, for each user in a first set of users in the identified queue, (i) the distance between the pickup location 123 of that user and the current location 135 of the driver, and/or (ii) an estimated travel time for the driver from the current location 135 to the pickup location 123 of that user. The first set of users can correspond to a predefined number of users that have the oldest timestamps as compared to the other users that are not in the first set of users in the identified queue. If there are eight users, for example, in the queue, the first set of users can correspond to the first four users that requested transport—and consequently, have the four oldest timestamps. The client select 118 can select the user from the first set having the shortest distance or estimated travel time for the driver. In this manner, the client select 118 can provide fairness to requesting users by prioritizing the selection of users over other users based on who has been waiting the longest.

Depending on implementation, the client select 118 can perform the selection of a user based on one or more rules 167 from the rules database 165. An administrator of the system 100 can access the administrator interface 160 to provide input 161 corresponding to operational parameters 163. These parameters 163 can be stored in the rules database 165 as rules 167 that the client select 118 can use to select a user from a queue for a driver that has become available. The rules database 165 can store information for the selection process for the client select 118.

For example, one or more rules 167 can direct the client select 118 to prioritize or rank the users (or set of users) based on distance and/or estimated travel time (and/or other factors, discussed below). In one example, a rule can specify that the client select 118 select the user having the shortest distance between the current location 135 of the driver location to the pickup location 123 (regardless of timestamp), whereas another rule can instruct the client select 118 to select the user having the shortest distance from a first set of users having the oldest timestamp. In other examples, a rule can specify that the client select 118 select the user having the shortest estimated travel time between the current location 135 of the driver location to the pickup location 123 (regardless of timestamp), whereas another rule can instruct the client select 118 to select the user having the shortest estimated travel time from a first set of users having the oldest timestamp. In addition, one or more rules 167 can specify how the users in a particular queue can get grouped together in sets based on the respective timestamps. For example, an administrator can specify that the user selection be made from a first set of users having the oldest timestamps as compared to other users (e.g., five users in a set or seven users in a set). The first set can have the five oldest timestamps, the second set can have the next five oldest timestamps, and so forth.

According to some examples, one or more rules 167 can specify time constraints or limitations for the dispatch 110. For example, if a user has been waiting in the queue for a certain amount of time that exceeds a threshold time, application of the one or more rules 167 can cause the client select 118 to assign that user to the next available driver. In another example, if a user has been waiting in the queue for a certain amount of time that exceeds a threshold time, the dispatch 110 can provide a message to be transmitted to the user's client device 170 that no vehicles or drivers have been found for that user (e.g., the request manage 140 can provide an error message to the user).

In addition, the rules 167 can also specify prioritizing or ranking the users in a queue (or a set of users in a queue) based on one or more of (i) feedback information of a driver (e.g., drivers' ratings), (ii) feedback information of the users, (iii) whether any of the capable drivers have previously provided transport service for the requesting users (e.g., select or prioritize a requesting user that gave that previously used driver good feedback for the driver), (iv) driver preferences, (v) user preferences, (vi) personal information about the driver (e.g., gender, age, etc.), (vii) personal information about the user (e.g., from the client database 150), and/or other factors. Any combination of the discussed factors can be used by the client select 118 to prioritize the users in a queue (or a set of users in a queue) for purposes of selecting a user for an available driver. In one example, the rules 167 can enable different weights to be applied different factors for purposes of prioritizing the capable drivers.

One or more rules 167 can also specify how the queue manage 114 can maintain the queues 115. In one example, a requesting user can be notified (e.g., via the request manage 140) when making a transport request that a wait time is expected due to the high utilization condition. In such case, the user can specify (as part of the transport request 171) a maximum wait time (e.g., inputted by the user) that the user is willing to wait so that after the maximum wait time is exceeded, the user's transport request 171 can be canceled without penalty. In such examples, the rules 167 can cause the queue manage 114 to include a maximum wait time as an entry with the user's ID 121 in a respective queue 115 and cause the queue manage 114 to remove the entry for that user when the maximum wait time is exceeded.

When the client select 118 selects a user from an identified queue for the driver, the dispatch 110 can transmit an invitation message 183 to the driver device 180 of the driver (e.g., using the driver ID 133) via the driver device interface 130. The invitation message 183 can be viewed as part of an interface of a service application running on the driver device 180. The invitation message 183 can include information about the requesting user, the pickup location of the user, and provide selectable features to enable the driver to accept the transport service or reject/decline the transport service. If the driver declines the transport service, the dispatch 110 receives the rejection (via the driver device interface 130) and the client select 118 is notified that the driver has rejected the transport service. The client select 118 can then select another user from the queue 115 for the driver. In such case, the user ID of the user that has not been accepted by the driver can remain in the queue until a next driver becomes available. The driver select 118 can continue to select a user each time a rejection is received until there are no more users available in the queue.

If the driver accepts the transport service, the dispatch 110 receives the acceptance and provides information about the driver to the request manage 140 (or the driver's ID 133 so that the request manage 140 can retrieve necessary driver information from the driver database 116). The request manage 140 can notify the selected user by transmitting a status message 127 via the client device interface 120 to the user's client device 170 that a driver will provide the transport service for the user. The status message 127 can include information, such as information about the driver (e.g., an image and name of the driver, vehicle license plate number) and information about the transport service (e.g., estimated time of arrival). The request manage 140 can provide the information about the arranged transport service to the requesting user's client device 170.

In addition, when the driver accepts the transport service, the dispatch 110 also notifies the client select 118 and/or the queue manage 114 that the driver has accepted the transport service for the selected user. The queue manage 114 can update the queue(s) 115 to remove the selected user's ID 121 from the respective queue 115. The queue manage 114 can dynamically update the queues 115 in real-time based on changes in the status of the transport requests. For example, the queue manage 114 can also remove an entry of a user in a queue 115 when the user cancels the transport request, or when a maximum wait time has exceeded (e.g., designated by the user or designated as a default wait time for all users set by an administrator, such as fifteen minutes). As an addition or an alternative, the client select 118 can inform the queue manage 114 when a user is selected and/or when the driver accepts the invitation to provide the transport service for that user in order to notify the queue manage 114 to update the queues 115. Once the driver accepts the transport service, the driver can travel to the pickup location 123 of the user and provide transport service for that user to the user's destination location (e.g., the destination location 127).

The dispatch 110 can determine when the transport service has been completed based on information received from the driver device and/or the client device 170 (e.g., via the driver tracking 112), and provide information about the completed transport service to the request manage 140 and to the payment processing 145. The payment processing 145 can use the information about the completed transport service and arrange for payment to be made from a financial account associated with the user via an accounting message 147 (e.g., to an external financial system). The request manage 140 can provide the status message 127 to indicate to the user that the transport service has been completed and to enable the user to view information about the completed transport service update the client information for the user in the client database 150 (e.g., log the trip, generate a receipt).

According to some examples, the system 100 can also determine a price for the fare of the transport service arranged for the user. When a user first makes the transport request 121, the request manage 140 can notify the user that a wait time is expected due to the high utilization condition and that the price for the fare is higher than normal (such as 1.5 times or 2 times the normal rate for when there is no high utilization condition). Because prices can vary depending on whether the current service conditions are normal, high utilization, or extremely high utilization (e.g., based on the number of requesting users as compared to the number of drivers on duty in a given geographic region), for example, it is beneficial to provide a set price for a requesting user. A requesting user can have the price for the fare be set or “locked” at the price when the user made the request, so that if prices go up as a result of the current conditions changing from high utilization to extremely high utilization, that user can still have the lower price despite receiving transport service fifteen minutes later. In another example, the price the user receives can be dynamic so that the user gets the price at the time the user is selected from the queue for a driver. In such case, if the price has gone up from the time the user first made the transport requests 171 to the time the user is selected from the queue, the request manage 140 can send the user a message 127 that tells the user that a driver has been assigned but that the price has gone up, and can request confirmation from the user that the user still wants the transport. After receiving confirmation, the dispatch 110 can transmit the invitation message 183 to the driver. If the user does not confirm the price increase, the queue manage 114 can remove that user from the respective queue 115 and the client select 118 can select another user from the queue 115 based on the vehicle type, the pickup locations of the users in the queue 115 and the current location of the driver.

In this manner, the dispatch 110 can optimize the method in which a transport service can be arranged between a user and a driver, and in particular, can optimize the transport service to be arranged during times of high utilization of drivers. In addition, the dispatch 110 can select a user based on timestamps to maintain overall fairness while also reducing the amount of travel time or down time for an available driver.

While some examples described herein illustrate the system 100 selecting one user ID for arranging a transport service when one driver becomes available during a time of high utilization, in other examples, multiple user IDs can be selected for arranging multiple transport services when multiple drivers become available around the same time (e.g., within 30 seconds of each other). For example, during a time of high utilization in a given geographic region, the dispatch 110 can add requesting users' IDs in a given queue 115 for the geographic region even with one or more drivers being available at the time a transport request 171 is received. The dispatch 110 can arrange multiple transport services for multiple users that are waiting (e.g., whose IDs are in the queue 115) when multiple drivers become available at around the same time in order to optimize the arrangement of the transport services.

An example is described with respect to FIG. 1 for purpose of illustrating intelligent queueing to optimize the arrangement of transport services for multiple users. For example, four users (U1, U2, U3, U4) may have requested transport services in a given geographic region at around the same time (e.g., five seconds apart from each other) during a period of high utilization. U1 may have requested first, then U2, and so on. The system 100 can determine that a time of high utilization exists in a given region from current conditions associated with the geographic region. At the time the four users requested transport services, one driver, D1, may have been available in the given region. The queue manage 114 can add the four user IDs corresponding to the four user in a queue corresponding to the given region. For example, rather than processing the transport request for U1 and arranging the transport service for U1 with the available driver, D1, the dispatch 110 can wait a predetermined amount of time to determine if other users would also make a request and/or if other drivers would become available in the given region. In this example, the three additional users have made transport requests after U1.

Shortly after the fourth user, U4, made the transport request, another driver, D2, may become available in the given region. In this example, the dispatch 110 can determine (e.g., based on one or more rules) that a predetermined number of drivers are available (e.g., two, in this particular example) to perform the multiple transport service arrangement process for the users in the queue 115. The dispatch 110 can also determine the current locations 135 of the two drivers in the given region. The client select 118 then perform calculations to determine metrics relating to each of the four users with respect to each of the two available drivers. The metrics can by a value corresponding to distance or a value corresponding to time. For example, the client select 118 can determine, for each user, (i) the distance from the current location of D1 to that user's pickup location, and/or (ii) the estimated travel time of D1 from the current location of D1 to that user's pickup location. Similarly, the client select 118 can determine, for each user, (i) the distance from the current location of D2 to that user's pickup location, and/or (ii) the estimated travel time of D2 from the current location of D2 to that user's pickup location.

In this example, the client select 118 can select users based on estimated travel times (specified in minutes, for example). For U1, the estimated travel time for D1 can be 8 minutes and the estimated travel time for D2 can be 6 minutes. For U2, the estimated travel time for D1 can be 4 minutes and the estimated travel time for D2 can be 3 minutes. For U3, the estimated travel time for D1 can be 6 minutes and the estimated travel time for D2 can be 9 minutes. For U4, the estimated travel time for D1 can be 5 minutes and the estimated travel time for D2 can be 7 minutes. If, for example, the client select 118 had selected a user from the four users in the queue 115 for the D1, the client select 118 may have selected U2 to be provided transport by D1 because 4 minutes is the shortest estimated travel time compared to the others.

However, by arranging multiple transport services for multiple users at around the same time, the dispatch 110 can optimize the arrangement of the transport services. Instead of assigning D1 to U2, the client select 118 can perform an additional computation to determine the lowest average estimated travel time for the two drivers when paired with two of the users. In this case, the client select 118 can determine that assigning U2 to D2 (3 minutes of estimated travel time) and assigning U4 to D1 (5 minutes of estimated travel time) results in the lowest travel times for the two drivers (e.g., an average of 4 minutes of estimated travel time). In this manner, by using a queue, the dispatch 110 can arrange multiple transport services around the same time in order to optimize the overall performance of the system 100 (and reduce collective waste, in terms of time, for drivers).

### Methodology

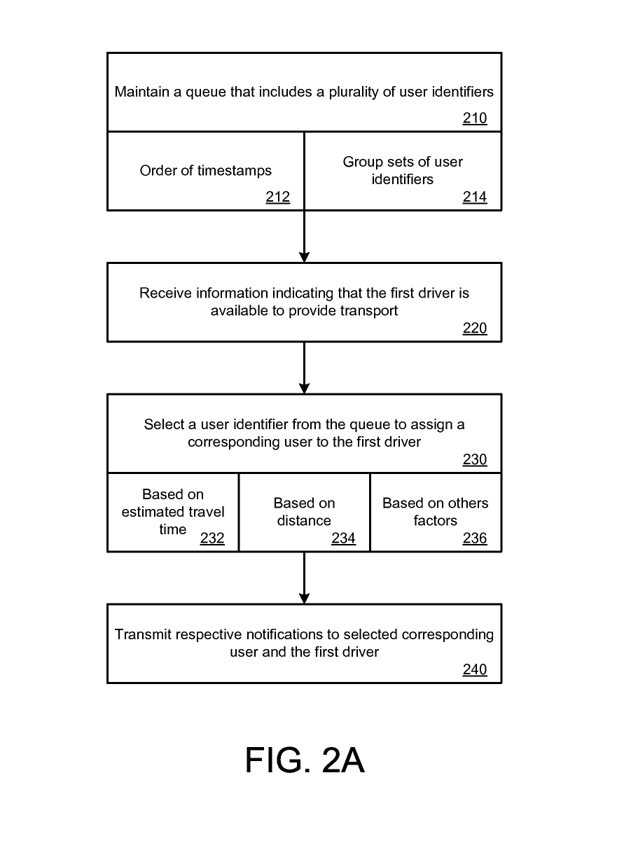

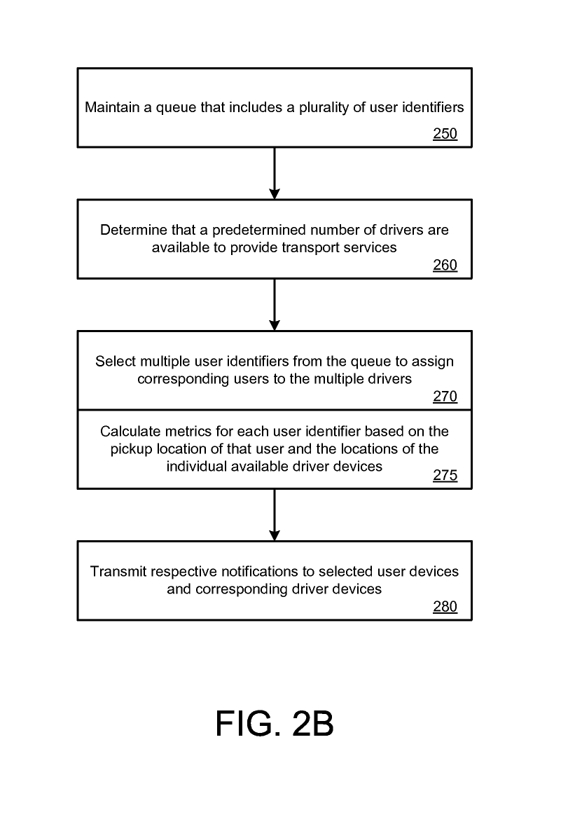

FIG. 2A illustrates an example method for arranging an on-demand service for a user using one or more queues. A method such as described by an example of FIG. 2A can be implemented using, for example, components described with examples of FIG. 1. Accordingly, references made to elements of FIG. 1 are for purposes of illustrating a suitable element or component for performing a step or sub-step being described.

Referring to FIG. 2A, the system 100 can maintain one or more queues that includes a plurality of user IDs (210). During times of high utilization in which the number of drivers in a geographic region is significantly less than the number of users that are requesting transport service (and/or when no drivers are available in the geographic region at a time a request for transport is made by a user), the system 100 can place a user ID of a corresponding user that made a transport request 171 in a particular queue 115. According to an example, a transport request 171 can include a user ID 121, a pickup location 123, and a vehicle type 125. Based on the pickup location 123 and the vehicle type 125, the system 100 can place an entry of the user (using the user ID 121) in a respective queue 115 that corresponds to a particular geographic region in which the pickup location 123 is located in and/or a vehicle type requested by the user.

In some examples, the queue 115 can be maintained using the timestamps of the transport requests for the users (212). When a transport request 171 is made by the user or received by the system 100, a timestamp can be associated with the request for that user. The queue manage 114 of the system 100 can, for example, manage an order or ranking of the entries in the queue 115 based on the timestamps corresponding to the entries. In addition, in one example, the queue manage 114 can also group the entries or user IDs 121 of the plurality of users in the queue 115 using the timestamps (214). For example, the grouping can enable the client select 118 to select a user from a particular group of users (as opposed to all users in the queue 115) so that the group of users having the oldest timestamps can have priority to be assigned a driver than another set or group of users having newer timestamps. The system 100 can continue to receive transport requests and assign the user IDs and its corresponding transport request information in an appropriate queue(s) 115 (e.g., update the one or more queues 115).

When a driver in a given geographic region becomes available (e.g., the driver goes on-duty after being off-duty or has finished providing transport for another user), the driver can operate the driver's computing device 180 to update her status 131. The system 100 can receive the driver's ID 133 and information about the driver's availability, e.g., indicating that the driver is available to provide transport to users in the given geographic region, from the driver device 180 (220). The system 100 can also receive (e.g., as part of the status information or separately) the current location 135 of the driver.

The system 100 can use the current location 135 of the driver to determine which queue or which set of users that driver can provide transport for (e.g., the driver may be positioned in the given region). For example, the current location 135 of the driver can be within a predefined geographic region (e.g., a region that is selected or configured by an administrator of the system 100) so that the driver can provide transport service for those users who have pickup locations within that predefined geographic region. In another example, the driver can be determined to be able to provide transport for users in multiple queues that correspond to multiple geographic regions if those users have pickup locations within a particular distance or estimated travel time from the current location 135 of the driver. In response to receiving the information indicating that the driver is available to provide transport, the system 100 can identify one or more corresponding queues 115 and select a user from the one or more queues 115 based on (i) the vehicle type specified by the users in the one or more queues 115, (ii) the vehicle type of the driver, (iii) the pickup locations of the users in the one or more queues 115, and/or (iv) the current location 135 of the driver (230).

According to examples, the client select 118 can select, from a queue (or from a predefined set/group of users in a queue having the oldest timestamps), a user ID to assign to the driver based on the estimated travel time of that driver to the pickup locations of the users in the queue (or the predefined group of users in the queue) (232). For example, for each user in the queue (or for each user in the predefined group of users), the client select 118 can determine the estimated travel time from the current location 135 of the driver to the respective pickup location of that user. The estimated travel time can be determined based on an expected or predicted route of travel, current weather conditions, traffic conditions, day and time of day, etc. The client select 118 can then select the user having the shortest estimated travel time.

As an addition or an alternative, the client select 118 can also select a user ID based on distance (234). For example, the client select 118 can determine, for each user in the queue (or for each user in the predefined group of users), the distance (either straight line distance from point to point or total distance that a driver would travel along an expected or predicted route) from the current location 135 of the driver to the respective pickup location of that user. The route can be an expected or predicted route of travel that a driver would take based on current weather conditions, traffic conditions, historical information of the driver, day and time of day, etc. The client select 118 can then select the user having the shortest distance time. In some examples, the client select 118 can also select a user based on a combination of estimated travel time, distance, and other factors (such as whether the driver has previously driven any of the users in the queue and/or has received a positive feedback as opposed to a negative feedback, user and/or driver preferences, etc.) (236).

The system 100 can then transmit respective messages to the devices of the selected user and the driver (240). According to an example, the dispatch 110 can first send an invitation message to that driver's computing device 180 with information about the selected user. The information can include the user ID of the selected user, the pickup location, ratings/feedback information of the selected user, an image of the selected user, and other user information, and enable the driver to either reject or accept the invitation. If the driver accepts the invitation, the system 100 can (e.g., via the dispatch 110 and/or the request manage 140) communicate a status message to the selected user notifying that user that a driver has been selected/assigned to the user. The status message can indicate the driver's estimated time of arrival to the user's pickup location as well as a visual graphic showing the driver's location and movement on a map. The system 100 can also update the respective queue to remove the selected user ID from the queue.

If the driver does not accept the invitation, the dispatch 110 receives the rejection and the client select 118 selects another user from the queue or from the set/group of users in the queue. In one example, the previously selected user ID can remain in the queue. After selecting the next user ID, the dispatch 110 can transmit another invitation message to the driver device 180 with information about the next user. The process can continue until (i) the driver is timed out, e.g., designated as not being available for a predetermined duration of time because the driver rejected a predetermined number of invitations, (ii) the driver accepts the invitation, and/or (iii) no more entries for users are left in the queue.

FIG. 2B illustrates another example method for arranging an on-demand services using one or more queues. A method such as described by an example of FIG. 2B can be implemented using, for example, components described with examples of FIG. 1. Accordingly, references made to elements of FIG. 1 are for purposes of illustrating a suitable element or component for performing a step or sub-step being described. In addition, in one example, the processes described in FIG. 2B may also be performed by the service arrangement system in conjunction with the processes described in FIG. 2A.

Referring to FIG. 2B, the dispatch 110 can maintain a queue that includes a plurality of user IDs (250). For purpose of simplicity, in the example of FIG. 2B, the queue can correspond to a particular geographic region in which a high utilization condition is present. Each of the plurality of user IDs in the queue can correspond to a user that has made a transport request having a specified pickup location within the geographic region. The dispatch 110 can manage the queue by adding user IDs to the queue when additional transports requests are made in association with the given region or by deleting user IDs from the queue when the previously made transport requests are canceled by the respective users.

The system 100 can determine when a predetermined number of drivers are available to provide transport services in the given region (260). Depending on implementation, the predetermined number of drivers can correspond to a specific number, a ratio of a number of available drivers as compared to a number of users in the queue, or a ratio of a number of available drivers as compared to a number of users that have the service application running on the respective client devices in the given region. When the dispatch 110 determines that the predetermined number of drivers are available, the dispatch 110 can perform computations using location data in order to arrange multiple transport services for multiple users in the queue to be provided by multiple available drivers.

The dispatch 110 can select multiple user identifiers from the queue to assign corresponding users to the multiple drivers (270). The dispatch 110 can make the selection by calculating metrics for individual users in the queue. According to an example, the dispatch 110 can calculate, for each user ID, metrics that are based on the pickup location of the corresponding user and the current locations of individual available drivers in the given region (275). For purpose of simplicity, assuming there are N users in the queue and there are M available drivers (e.g., where N can be greater than M), the dispatch 110 can determine for each of the N users, M number of values, where each of the M values is based on that user's pickup location and the current location of one of the M drivers. The value can correspond to (i) a straight line distance from the pickup location of the user to a current location of a driver, (ii) a total predicted distance that a driver would travel along an expected or predicted route from the current location of that driver to the pickup location of the user, or (iii) an estimated travel time a driver would travel from the current location of that driver to the pickup location of the user along an expected or predicted route. The dispatch 110 can then select a set of users in the queue to be provided transport by the M available drivers based on the computed metrics.

For example, if the dispatch 110 is to select three users for three drivers based on straight line distances, the dispatch 110 can select a first user for a first driver, a second user for a second driver, and a third user for a third driver so that these three users, taken together, have the lowest total distance (or lowest average distance) between the individual pickup locations of these users and the respective current location of the individual drivers, as compared to another combination of three users in the queue. Similarly, if the dispatch 110 is to select four users for four drivers based on estimated travel times, the dispatch 110 can select and match each of the four users to an available driver so that these four users, taken together, have the lowest total travel time (or lowest average travel time) between the individual pickup locations of these users and the respective current location of the individual drivers, as compared to another combination of four users in the queue. The dispatch 110 can make the computations based on the most recent current location data point received from each of the available drivers' devices.

The dispatch 110 can transmit, to the selected users' devices and to the respective drivers' devices, notifications about the respective arranged transport services (280). According to an example, such notifications can be provided as an in-application message or interactive user interface (e.g., in the client service application) or as a notification message separate from the client service application. Referring back to the example, if M users are selected (from N total users in the queue) to be transported by M drivers, the dispatch 110 can transmit to each of the M drivers' devices, an invitation notification to enable that driver to accept the invitation and provide the transport service for a respective user. The invitation notification can provide information about the respective user (e.g., a name and/or photo of the user) and that user's pickup location (e.g., shown with a graphic feature on a map and/or with textual information showing the address, landmark, or street intersection, etc.). In some examples, the dispatch 110 can transmit, to each of the selected users' devices, notifications about the arranged transport service for that user when the respective driver accepts the invitation.

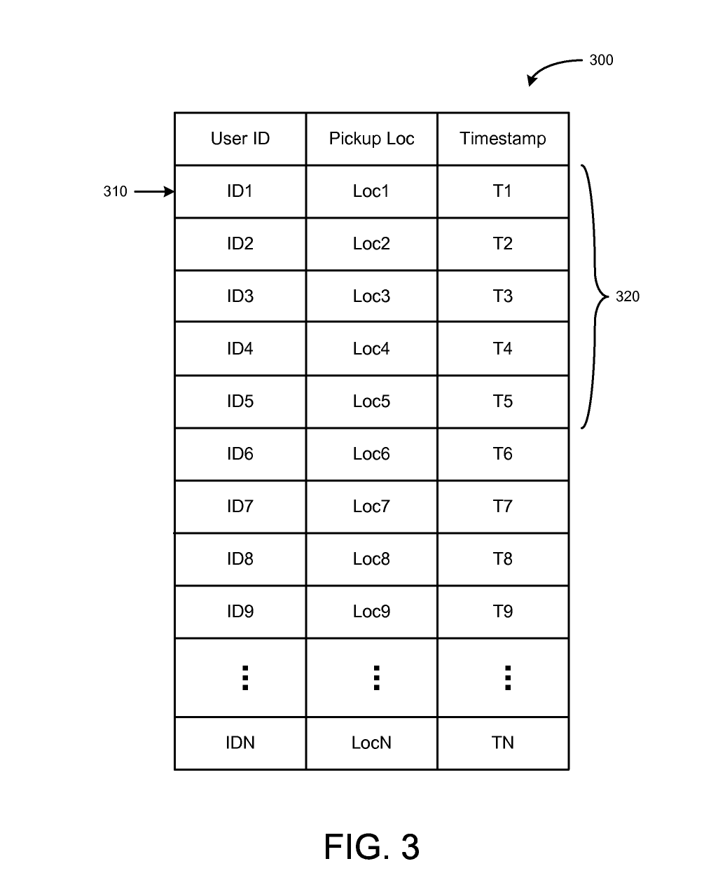

FIG. 3 illustrates an example of a queue as described herein. References made to elements of FIG. 1 for purposes of illustration. According to an example, a queue 300 can be a database or table that is stored in a memory resource of the system 100 of FIG. 1. The queue 300 can include a plurality of entries 310, where each entry 310 corresponds to a particular user that has made a request for a transport service, such as during a time of high utilization. Each entry 310, for example, can include a user ID, a pickup location (e.g., represented as a location data point, such as a latitude and a longitude), and/or a timestamp corresponding to the user's transport request. The queue 300 can also be specific to a particular geographic region and/or a particular vehicle type. For example, the entries 310 of the users in the queue 300 can correspond to users that have each made a transport request for the same particular vehicle type (e.g., black town car) and having a pickup location within the same geographic region (e.g., San Francisco, Calif.). Another queue can correspond to the San Francisco, Calif. geographic region for a different vehicle type (e.g., SUV), while another queue can correspond to the San Jose, Calif. geographic region for a black town car.

The system 100, for example, can also group entries 310 together based on timestamps. For example, timestamps T1-T5 can represent the oldest timestamps of transport requests as compared to the other timestamps. The queue manage 114 can group those entries 310 together as a first group 320. The queue manage 114 can group the next set of entries 310 as a second group, and so forth. When a driver having a current location in San Francisco, Calif. and having the vehicle type, black town car, becomes available, the client select 118 can access the corresponding queue 300 (e.g., the queue that corresponds to black town car vehicle types and San Francisco, Calif.) and select a user from the first group 320 based on the pickup locations of those users and the current location of the driver. Once a user is selected, such as the user with the user ID3, the queue manage 114 can update the queue 300 by removing user ID3, and updating the group 320 to include another user, ID6, for example.

### Hardware Diagrams

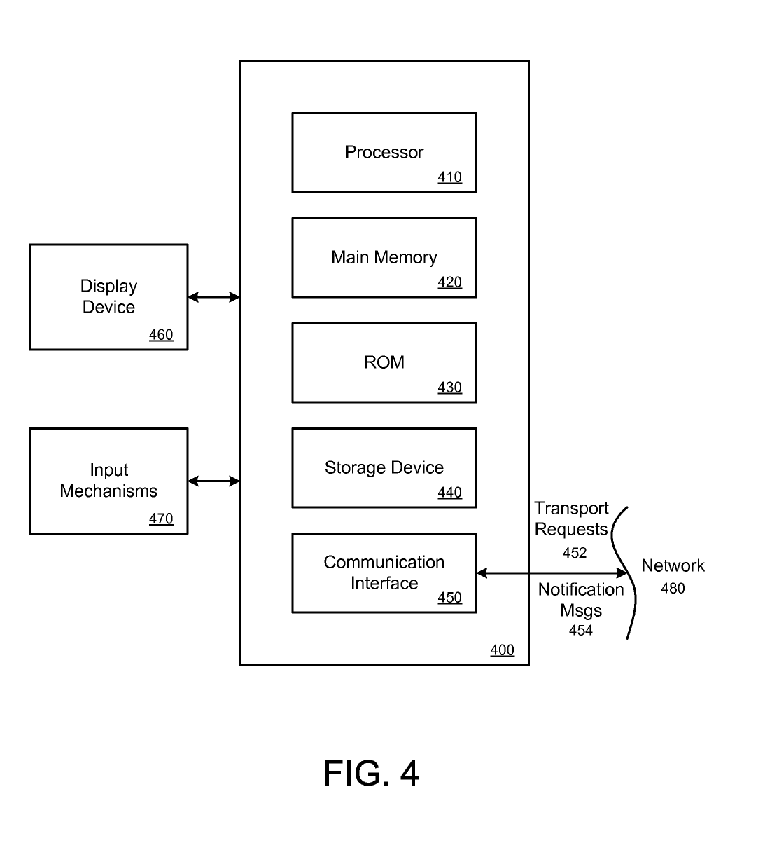

FIG. 4 is a block diagram that illustrates a computer system upon which examples described herein may be implemented. For example, in the context of FIG. 1, the system 100 may be implemented using a computer system such as described by FIG. 4. The system 100 may also be implemented using a combination of multiple computer systems as described in FIG. 4.

In one implementation, the computer system 400 includes processing resources 410, a main memory 420, a read-only memory (ROM) 430, a storage device 440, and a communication interface 450. The computer system 400 includes at least one processor 410 for processing information. The main memory 420, such as a random access memory (RAM) or other dynamic storage device, can store information and instructions to be executed by the processor 410. The main memory 420 also may be used for storing temporary variables or other intermediate information during execution of instructions to be executed by the processor 410. The computer system 400 may also include other static storage device for storing static information and instructions for the processor 410. The storage device 440, such as a magnetic disk or optical disk, is provided for storing information and instructions, such as instructions for implementing components described in FIG. 1, such as the dispatch 110. For example, the instructions for the dispatch 110 can be executed by the processing resources 410 to perform the queueing and selection processes described in FIGS. 1 through 3.

The communication interface 450 can enable the computer system 400 to communicate with one or more networks 480 (e.g., cellular network) through use of the network link (wireless or using a wire). Using the network link, the computer system 400 can communicate with one or more computing devices, such as client devices and driver devices, and one or more servers. In some variations, the computer system 400 can receive a transport request 452 from a client device of a user via the network link. The transport request 452 can include the user's user identifier, a pickup location, a destination location, and/or a vehicle type selection. During times of high utilization, the transport request 452 can be processed by the processor 410 and the processor 410 can update a respective queue with the user's identifier, the pickup location, and/or a time stamp. When the computer system 400 receives information from a driver that he or she is available for providing transport, the processor 410 can select a user from the queue based on the location information of the users in the queue and the current location of the driver. The processor 410 can transmit, over the network 480, an invitation message to the driver to provide transport for the selected user, and when the driver accepts the invitation, the processor 410 can transmit, over the network 480, a status message 454 to the client device (e.g., that made the transport request) notifying the user that a driver has been assigned to the user.

The computer system 400 can also include a display device 460, such as a cathode ray tube (CRT), an LCD monitor, or a television set, for example, for displaying graphics and information to a user. An input mechanism 470, such as a keyboard that includes alphanumeric keys and other keys, can be coupled to computer system 400 for communicating information and command selections to processor 410. Other non-limiting, illustrative examples of input mechanisms 470 include a mouse, a trackball, touch-sensitive screen, or cursor direction keys for communicating direction information and command selections to the processor 410 and for controlling cursor movement on the display 460.

Examples described herein are related to the use of computer system 400 for implementing the techniques described herein. According to one example, those techniques are performed by the computer system 400 in response to the processor 410 executing one or more sequences of one or more instructions contained in the main memory 420. Such instructions may be read into the main memory 420 from another machine-readable medium, such as the storage device 440. Execution of the sequences of instructions contained in the main memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

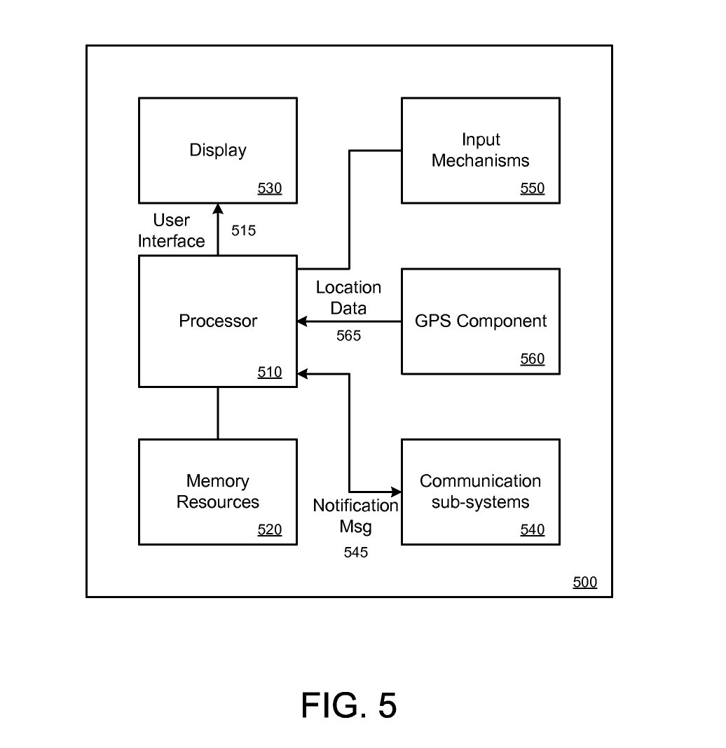

FIG. 5 is a block diagram that illustrates a mobile computing device upon which examples described herein may be implemented. In one example, a computing device 500 may correspond to a mobile computing device, such as a cellular device that is capable of telephony, messaging, and data services. The computing device 500 can correspond to a client device or a driver device. Examples of such devices include smartphones, handsets or tablet devices for cellular carriers. The computing device 500 includes a processor 510, memory resources 520, a display device 530 (e.g., such as a touch-sensitive display device), one or more communication sub-systems 540 (including wireless communication sub-systems), input mechanisms 550 (e.g., an input mechanism can include or be part of the touch-sensitive display device), and one or more location detection mechanisms (e.g., a GPS component) 570. In one example, at least one of the communication sub-systems 540 sends and receives cellular data over data channels and voice channels.

The processor 510 is configured with software and/or other logic to perform one or more processes, steps and other functions described with implementations, such as described by FIGS. 1 through 3, and elsewhere in the application. The processor 510 is configured, with instructions and data stored in the memory resources 520, to operate a service application as described in FIGS. 1 through 3. For example, instructions for operating the service application in order to display user interfaces can be stored in the memory resources 520 of the computing device 500.

A user can operate a client device (such as a computing device 500) to operate a client service application in order to make a request for a transport service. A location data point 565, such as a location data point corresponding to the current location of the computing device 500, can be determined from the GPS component 570. The location data point 565 can be wirelessly transmitted to the system via the communication sub-systems 540 as part of the request for the transport service. In another example, the user can specify a different location data point than the current location of the computing device as the pickup location (e.g., by inputting an address or making a selection on a map via the input mechanisms 550) to be transmitted as part of the request for transport. The intelligent dispatch system can receive the request from the computing device 500 and arrange a transport service for the user, such as described in FIGS. 1 through 3. The system can transmit a notification or status message(s) 545 regarding the arranged transport service to the computing device 500 via the communication sub-systems 540 (e.g., that a driver is being selected, that a driver has accepted). The status messages 545 can be processed by the processor 510 to provide the status information to the user as part of a user interface 515 on the display 530.

Similarly, a driver can operate a computing device 500 as the driver device and operate driver service application to receive invitations (e.g., as a notification message 545) from the intelligent dispatch system. The computing device 500 can determine the current location data point 565 via the GPS component 560 and transmit the location data point 565 to the intelligent dispatch system. The computing device 500 can also provide to the intelligent dispatch system, via the communications sub-systems 540, information about the driver's availability through use of the driver service application.

The processor 510 can provide a variety of content to the display 530 by executing instructions and/or applications that are stored in the memory resources 520. One or more user interfaces 515 can be provided by the processor 510, such as a user interface for the client service application or a user interface for the driver service application, which can include the information corresponding to the status messages 545. While FIG. 5 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method for arranging a transport service through use of computing devices, the method being performed by one or more processors of a computing device and comprising:
for a given geographic region, receiving a plurality of transport requests from a plurality of client devices, each transport request including a pickup location that is within the given geographic region and that is specified by a user that operates the respective client device;
storing, in a queue corresponding to the given geographic region, a plurality of user identifiers corresponding to the plurality of users that made the plurality of transport requests, the queue being stored in a memory resource that is accessible by the computing device;
receiving, from a driver device of a driver, (i) information indicating that the driver is available to provide a transport service for a user, and (ii) information about a current location of the driver device, the current location being within the given geographic region; and
in response to receiving the information indicating that the driver is available, selecting a user identifier from the queue based, at least in part, on (i) the pickup locations specified by the plurality of users and (ii) the current location of the driver device, wherein the user identifier is selected to assign a corresponding user to the driver.

2. The method of claim 1, wherein storing the plurality of user identifiers includes storing the plurality of user identifiers in an order based on a timestamp associated with each of the plurality of user identifiers, the timestamp for each user identifier corresponding to a time the computing device received the transport request from a client device associated with the corresponding user.

3. The method of claim 2, wherein selecting the user identifier from the queue includes selecting the user identifier from a first set of user identifiers in the queue, the first set of user identifiers corresponding to a predetermined number of user identifiers having the oldest timestamps.

4. The method of claim 3, wherein selecting the user identifier from the first set of user identifiers in the queue includes determining, for each of the first set of user identifiers, an estimated travel time from the current location of the driver device to the pickup location corresponding to that user identifier.

5. The method of claim 4, wherein selecting the user identifier from the first set of user identifiers in the queue includes selecting the user identifier having the shortest estimated travel time as compared to the estimated travel time of others of the first set of user identifiers.

6. The method of claim 1, wherein selecting the user identifier from the queue includes determining, for each of the plurality of user identifiers in the queue, an estimated travel time from the current location of the driver device to the pickup location corresponding to that user identifier.

7. The method of claim 6, wherein selecting the user identifier from the queue includes selecting the user identifier having the shortest estimated travel time as compared to the estimated travel time of others of the plurality of user identifiers.

8. The method of claim 1, wherein selecting the user identifier from the queue includes determining, for each of the plurality of user identifiers in the queue, a distance from the current location of the first driver to the pickup location corresponding to that user identifier.

9. The method of claim 8, wherein selecting the user identifier from the queue includes selecting the user identifier having the shortest distance as compared to the distance of others of the plurality of user identifiers.

10. The method of claim 1, further comprising:
in response to selecting the user identifier from the queue, transmitting, to the driver device, an invitation notification about the transport service for the corresponding user associated with the selected user identifier, the invitation notification enabling the driver to accept or reject providing transport for the corresponding user.

11. The method of claim 10, further comprising:
receiving, from the driver device, information corresponding to an acceptance of the invitation notification; and
in response to receiving the information corresponding to the acceptance, (i) transmitting a notification to the client device corresponding to the selected user identifier, the notification indicating that the driver has been assigned to provide transport for the corresponding user, and (ii) updating the queue by removing the selected user identifier from the queue.

12. The method of claim 1, wherein each transport request of the plurality of transport requests includes information about a specific vehicle type, and wherein the queue corresponds to the specific vehicle type.

13. A non-transitory computer-readable medium storing instructions that, when executed by one or more processors of a computing device, cause the computing device to:
for a given geographic region, receive a plurality of transport requests from a plurality of client devices, each transport request including a pickup location that is within the given geographic region and that is specified by a user that operates the respective client device;
store, in a queue corresponding to the given geographic region, a plurality of user identifiers corresponding to the plurality of users that made the plurality of transport requests, the queue being stored in a memory resource that is accessible by the computing device;
receive, from a driver device of a driver, (i) information indicating that the driver is available to provide a transport service for a user, and (ii) information about a current location of the driver device, the current location being within the given geographic region; and
in response to receiving the information indicating that the driver is available, select a user identifier from the queue based, at least in part, on (i) the pickup locations specified by the plurality of users and (ii) the current location of the driver device, wherein the user identifier is selected to assign a corresponding user to the driver.

14. The non-transitory computer-readable medium of claim 13, wherein the instructions cause the computing device to store the plurality of user identifiers by storing the plurality of user identifiers in an order based on a timestamp associated with each of the plurality of user identifiers, the timestamp for each user identifier corresponding to a time the computing device received the transport request from a client device associated with the corresponding user.

15. The non-transitory computer-readable medium of claim 14, wherein the instructions cause the computing device to select the user identifier from the queue by selecting the user identifier from a first set of user identifiers in the queue, the first set of user identifiers corresponding to a predetermined number of user identifiers having the oldest timestamps.

16. The non-transitory computer-readable medium of claim 15, wherein the instructions cause the computing device to select the user identifier from the first set of user identifiers in the queue by (i) determining, for each of the first set of user identifiers, an estimated travel time from the current location of the driver device to the pickup location corresponding to that user identifier, and (ii) selecting the user identifier having the shortest estimated travel time as compared to the estimated travel time of others of the first set of user identifiers.

17. The non-transitory computer-readable medium of claim 13, wherein the instructions cause the computing device to select the user identifier from the first set of user identifiers in the queue by (i) determining, for each of the first set of user identifiers, a distance from the current location of the driver device to the pickup location corresponding to that user identifier, and (ii) selecting the user identifier having the shortest distance as compared to the estimated travel time of others of the first set of user identifiers.

18. A method for arranging transport services through use of computing devices, the method being performed by one or more processors of a computing device and comprising:
for a given geographic region, receiving a plurality of transport requests from a plurality of client devices, each transport request including a pickup location that is within the given geographic region and that is specified by a user that operates the respective client device;
storing, in a queue corresponding to the given geographic region, a plurality of user identifiers corresponding to the plurality of users that made the plurality of transport requests, the queue being stored in a memory resource that is accessible by the computing device;
determining, based on information received from a set of driver devices, that a predetermined number of drivers operating the set of driver devices are available in the given geographic region to provide transport services for users, the information including a current location of each driver device;
for each of the plurality of user identifiers, determining a set of metrics based on the pickup location associated with that user identifier and the current location of each driver device; and
arranging multiple transport services by selecting the predetermined number of user identifiers from the queue to be assigned to the predetermined number of drivers based on the set of metrics associated with each of the plurality of user identifiers.

19. The method of claim 18, wherein for each of the plurality of user identifiers, determining the set of metrics includes determining an estimated travel time from the current location of each driver device to the pickup location corresponding to that user identifier.

20. The method of claim 18, wherein for each of the plurality of user identifiers, determining the set of metrics includes determining a distance from the current location of each driver device to the pickup location corresponding to that user identifier.
